(19) United States
(12) Patent Application Publication
(10) Pub. No.: US 2024/0418203 A1
(43) Pub. Date: Dec. 19, 2024

(54) METHOD FOR MAKING AT LEAST ONE THREADED BUSHING IN A HOLLOW PROFILE, HOLLOW PROFILE AND VEHICLE COMPRISING SUCH A HOLLOW PROFILE

(71) Applicant: Smartfloor B.V., Almelo (NL)

(72) Inventors: Peter Alexander Jan HAARHUIS, Almelo (NL); Gerrit-Jan Gerwin VAN OS, Almelo (NL); Miron TIGCHELER, Almelo (NL)

(73) Assignee: Smartfloor B.V., Almelo (NL)

(21) Appl. No.: 18/702,991

(22) PCT Filed: Sep. 28, 2022
(86) PCT No.: PCT/NL2022/050543

§ 371 Date: Apr. 19, 2024

(30) Foreign Application Priority Data
Oct. 27, 2021 (NL) 2029525

(51) Int. Cl. F16B 37/04; A61G 3/08; B60N 2/005; B62D 25/20

(52) U.S. Cl. CPC F16B 37/04; B62D 25/20; A61G 3/0808; B60N 2/005

(57) ABSTRACT

A method for making a threaded bushing in a hollow profile includes providing a hollow profile, and friction drilling the hollow profile using a friction drilling tool. The friction drilling tool is pressed against a first wall that extends substantially orthogonal to a longitudinal direction of the drilling tool and thereby melts through and deforms said first wall and after passing through the first wall contacts and thereby melts and deforms at least two second walls of the hollow profile that extend substantially orthogonal with respect to said the first wall and thereby substantially parallel to said longitudinal direction of the friction drilling tool, such that a substantially cylindrical shaped bushing is formed in the hollow profile. The method further includes screw thread tapping the substantially cylindrical shaped bushing using a thread tapping tool, thereby obtaining the at least one threaded bushing.

The invention relates to a method for making at least one threaded bushing in a hollow profile, a hollow profile comprising at least one threaded bushing as obtained by performing the method, and a vehicle comprising at least one such hollow profile, for example as a floor profile.

It is known per se to make at least one threaded bushing in a hollow profile. Such at least one threaded bushing is made in a wall of said hollow profile by for example first friction drilling a hole in said wall and next screw thread tapping the circumferential wall surrounding said hole. A disadvantage of the threaded bushing created by performing this method is that the length of the threaded bushing is relatively short, i.e. only somewhat longer than the thickness of said wall in which the bushing is made, such that the thread strength of the bushing is relatively low. For some applications, such as for example a floor profile to be mounted on the floor of a vehicle and for example used for mounting furniture, wheelchairs, or the like thereon, the thread strength of such a threaded bushing is insufficient and profiles having a massive core in which the threaded bushing is made are used instead. However, for this same application the weight of the profiles is an important factor, such that it would be preferred to use hollow profiles instead.

It is therefore an object of the invention to provide a method for making at least one threaded bushing in a hollow profile, wherein the at least one threaded bushing has an increased thread strength as compared to the threaded bushing as made by the method described above.

This object is achieved by a method of the type according to the preamble that comprises the steps of:

a) providing a hollow profile;

b) friction drilling the hollow profile using a friction drilling tool, wherein said friction drilling tool is pressed against a first wall that extends substantially orthogonal to a longitudinal direction of the drilling tool and thereby melts through and deforms said first wall and after passing through the first wall contacts and thereby melts and deforms at least two second walls of the hollow profile that extend substantially orthogonal with respect to said first wall and thereby substantially parallel to said longitudinal direction of the friction drilling tool, such that a substantially cylindrical shaped bushing is formed in the hollow profile;

c) screw thread tapping said substantially cylindrical shaped bushing using a thread tapping tool, thereby obtaining said at least one threaded bushing.

In accordance with the invention the friction drilling tool now also contacts and thereby melts and deforms said least two second walls of the hollow profile, which are the walls that extend substantially parallel to the longitudinal direction of the friction drilling tool such that the busing is formed in the length direction of those second walls. Because the bushing is now created in both the length direction of the second walls and in the thickness direction of the first wall, the length of the bushing is increased with respect to the prior art method in which the bushing is only created in the thickness direction of a wall. After the screw thread tapping step a threaded bushing having an increased thread strength as compared to the prior art method is thus created.

It is noted that said hollow profile may be at least hollow in the area where said at least one threaded bushing is made, which may for example be in the core of the profile such that the profile is a hollow core profile.

A distance between the at least two second walls, in particular between inner surfaces thereof, i.e. the surfaces of the walls that are directed to the other walls, is smaller than the diameter of the friction drilling tool used, such that the friction drilling tool will contact both or all second walls if it is correctly positioned in between, i.e. centered between the at least two second walls.

It is noted that more than two second walls may be provided, such as three, four, five or six second walls.

It is further noted that in particular a bit of the friction drilling tool, which bit may for example be substantially pen shaped having for example a conical or pointy pressing end, is pressed against and thereby through the first wall and in contact with the second walls.

It is further noted that the longitudinal direction of the friction drilling tool may in particular be defined in the longitudinal direction of said above described bit of the friction drilling tool.

It is further noted that the first and second walls are in particular melted and deformed in the area of the friction drilling tool, i.e. where the friction drilling tool is pressed against and/or is in contact with the walls.

In an embodiment of the method according to the invention the friction drilling tool is pressed against at least one third wall that extends substantially orthogonal between the second walls and parallel to the first wall at a distance therefrom and thereby melts through and deforms said third wall, said deformed third wall defining part of the substantially cylindrical shaped bushing.

The at least one third wall may provide additional strength to the bushing made.

Said at least one third wall is also drilled in substantially the thickness direction thereof.

The distance between the first wall and the or each third wall may be chosen as desired.

If desired multiple third walls may be provided, which may further increase the strength of the bushing made and/or in dependence of the length of the second walls wherein the third walls are regularly distributed over the length of the second walls.

The at least one third wall is in particular melted and deformed in the area of the friction drilling tool, i.e. where the friction drilling tool is pressed against and melts through the at least one third wall.

The deformed third wall is in particular part of the circumferential wall created by the friction drilling tool that defines the bushing.

The first wall, the second walls or part thereof that extend between the first and third wall, and the third wall may together define a substantially square transverse cross section of the profile prior to making the bushing, wherein transverse is defined substantially orthogonal with respect to the longitudinal direction of the profile.

In yet another embodiment of the method the second walls extend on both sides of the third wall as seen in the longitudinal direction of the drilling tool.

In such an embodiment the part of the hollow profile comprising said first, second, and third walls is substantially A-shaped prior to step b), wherein the legs of the A may be substantially parallel to each other, i.e. not inclined. This part of the hollow profile may in particular be substantially A-shaped in a transverse cross section of the profile prior to making the bushing.

The length of the threaded bushing may be substantially equal to a length of the second walls. As described above, this provides said relatively long and thereby relatively strong threading bushing.

The invention also relates to a hollow profile comprising at least one threaded bushing as obtained by performing the method as described above in any one or more of the above described embodiments and/or having any one or more of the above described features, alone or in any suitable combination.

Said hollow profile may be made of any suitable material, such as metal. More in particular, said hollow profile may for example be made of aluminum, steel or magnesium.

Said hollow profile may be any type of hollow profile and/or used for any desired application.

Said hollow profile may for example be an extruded profile.

Said hollow profile may in particular be an vehicle floor profile. As described above, in particular for such a profile the combination of low weight profiles have strong threaded bushings is important.

Said hollow profile may be an elongated profile having a length in a length direction that is larger than a width in a width direction.

Said length direction and width direction may be orthogonal to each other and may both lie in a plane of a first wall of the profile.

In an embodiment of the hollow profile according to the invention the hollow profile comprises multiple threaded bushings as obtained by performing the method as described above in any one or more of the above described embodiments and/or having any one or more of the above described features, alone or in any suitable combination.

In an embodiment of the hollow profile according to the invention the hollow profile comprises a first wall and at least two second walls that extend substantially orthogonal with respect to said first wall, wherein the second walls extend over substantially the entire length of the profile, and wherein the at least one threaded bushing is provided at any desired location.

In an embodiment of the hollow profile according to the invention the threaded bushing is obtained by locally deforming the first and second walls by means of said friction drilling tool and wherein outside the at least one threaded bushing the first and second walls remain undeformed and extend from the at least one threaded bushing in the length direction of said hollow profile.

In an embodiment of the hollow profile according to the invention the first wall and the at least two second walls are integrally formed as one piece over substantially the entire length of the hollow profile.

The invention also relates to a vehicle, comprising at least one hollow profile as described above in any one or more of the above described embodiments and/or having any one or more of the above described features, alone or in any suitable combination, wherein the hollow profile is attached to a floor of the vehicle.

The hollow profile may be attached to the floor of the vehicle in any suitable way, for example be attaching the profile to the floor using screws or bolts.

In an embodiment of the vehicle according to the invention a mounting profile is attached to the hollow profile by means of at least one screw or bolt that is screwed into a respective at least one threaded bushing, said mounting profile being arranged for mounting furniture, wheelchair restraints, or anything that needs mounting on the vehicle floor thereon.

It is noted that the at least one threaded bushing that is made by performing the method according to the invention is thus used for mounting said mounting profile thereof, but it may additionally or alternatively be used for mounting the hollow profile to the floor of the vehicle.

The invention will be further elucidated with reference to figures, wherein:

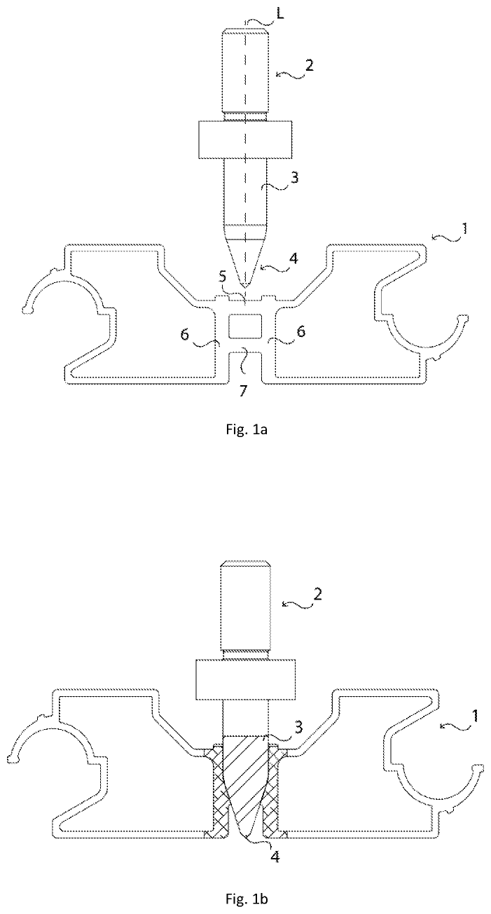

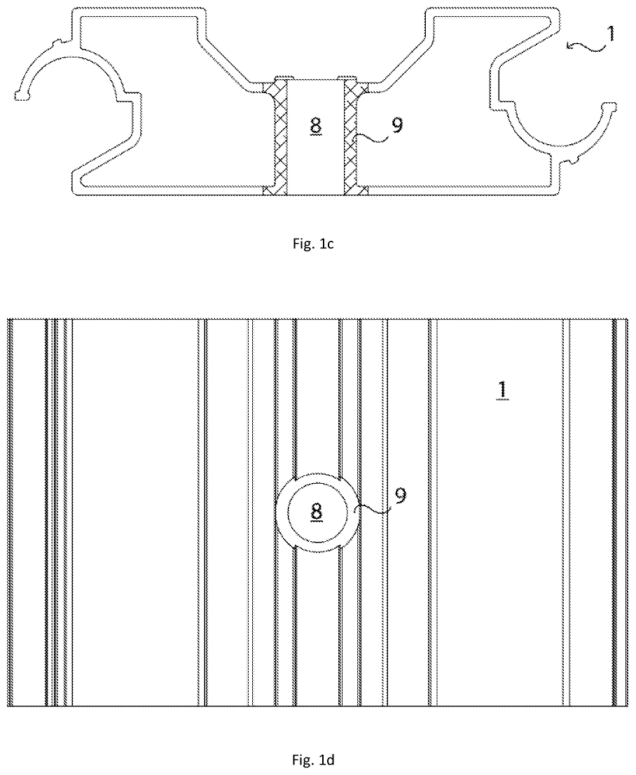

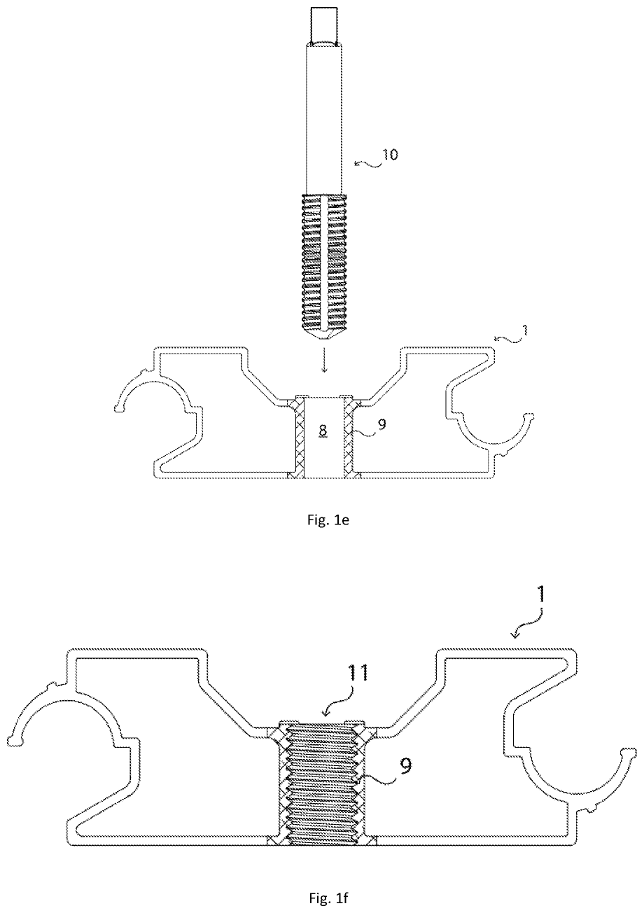

FIGS. 1a-1f show the steps of an exemplary embodiment of the method according to the invention;

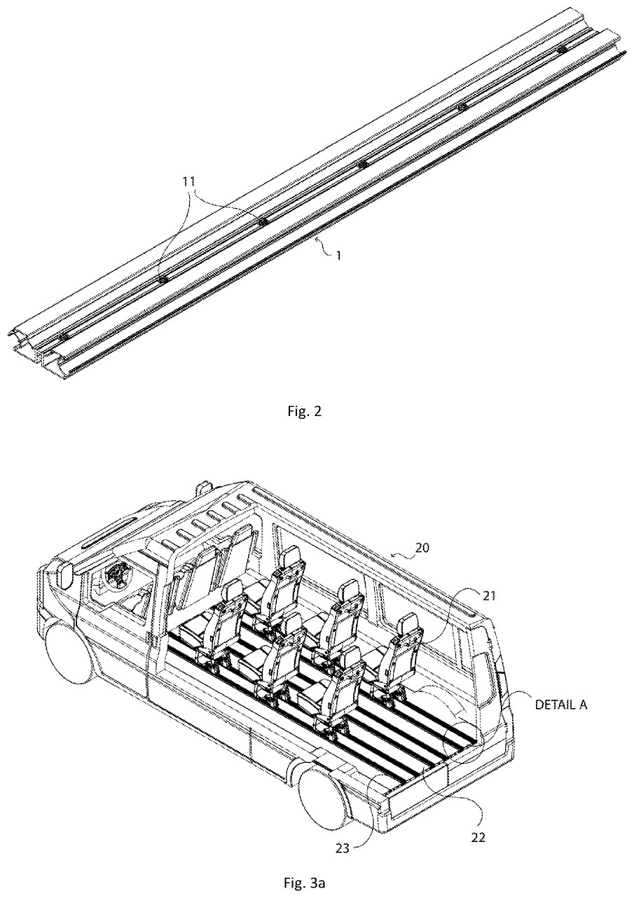

FIG. 2 shows a perspective view of a hollow profile obtained by performing the method of FIGS. 1a-1f;

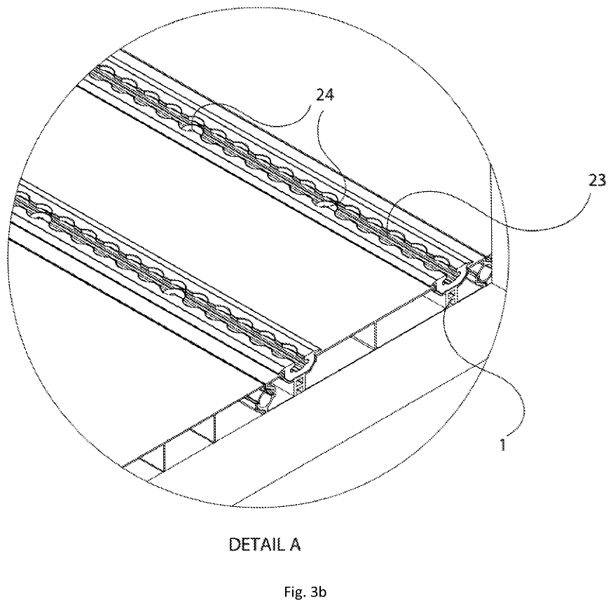

FIG. 3a shows a vehicle comprising a plurality of hollow profiles attached to the floor thereof, and

FIG. 3b shows a detail of FIG. 3a.

In the figures same features are referred to by same reference numerals.

FIGS. 1a-1f show the steps of an exemplary embodiment of a method for making at least one threaded bushing in a hollow profile 1. FIG. 1a shows a first step wherein a hollow profile 1 is provided, wherein the hollow profile 1 is shown in a cross-sectional view in the transverse direction of the longitudinal direction of the profile 1. The hollow profile 1 may be any suitable type of hollow profile made of any suitable material. For example the hollow profile may be a metal profile, more in particular an optionally extruded aluminum, steel or magnesium profile. In FIG. 1a a friction drilling tool 2 having a substantially pen-shaped bit 3 having a conical pressing end 4 is shown. As shown in FIG. 1b, said friction drilling tool and in particular the pressing end 4 of the bit 3 is pressed against a first wall 5 of the profile 1 that extends substantially orthogonal to a longitudinal direction L of the drilling tool 2 and thereby melts through and deforms said first wall 5 and after passing through the first wall 5 contacts and thereby melts and deforms in this embodiment two second walls 6 of the hollow profile 1 that extend substantially orthogonal with respect to said first wall 5 and thereby substantially parallel to said longitudinal direction L of the friction drilling tool 2. Next the bit 3 is pressed against in this embodiment one third wall 7 that extends substantially orthogonal between the second walls 6 and parallel to the first wall 5 at a distance therefrom and thereby melts through and deforms said third wall 7. The deformed first wall 5, second walls 6 and third wall 7 together define the circumferential wall 9 of a substantially cylindrical shaped bushing 8 that is thus formed in the profile 1 by the friction drilling tool 2, which bushing 8 is best visible in FIGS. 1c and 1d.

As is best visible in FIG. 1a, the core of the hollow profile 1 is substantially A-shaped with straight, parallel legs of the A prior to making the bushing 8. In this embodiment two second walls 6 and one third wall 7 are provided, but if desired more than two second walls 6 and more than one third wall 7 may be provided. The two second walls 6 are in this embodiment arranged as two opposing, parallel walls 6 that extend in the longitudinal direction of the hollow profile 1 over the length of the hollow profile 1. An advantage thereof is that the bushing may be made at any desired location, because the walls 6 extend over the entire length of the profile 1. If more second walls 6 would be provided these may extend in between the two second walls 6 that are shown in FIG. 1a, i.e. in the transverse direction of the profile 1, and these would thus have to be provided at the location where it is intended to make a bushing. For example such walls can be provided at regular interval positions. In this embodiment the third wall 7 extends between two second walls 6 at a location such that the two second walls 6 extend on both sides of the third wall 7. If desired more third walls 7 may be provided, for example at the free end of the second walls 6 or at any desired intermediate position. If desired, a said one third wall 7 may be located at a different position, for example at the free end of the second walls 6, i.e. the end of the second walls 6 that is opposite to the end where the first wall 5 is located.

In a next step as shown in FIG. 1e a thread tapping tool 10 is provided that is inserted into the bushing 8 in the longitudinal direction of the bushing 8 as shown by the arrow and that thereby screw thread taps said substantially cylindrical shaped bushing 8, such that said bushing 8 is now a threaded bushing 11 as shown in FIG. 1f.

FIG. 2 shows the hollow profile 1 in a longitudinal perspective view which shows that multiple threaded bushings 11 are made therein by performing the method steps of FIGS. 1a-1f. The threaded bushings 11 are in this embodiment evenly distributed over the length of the hollow profile 1.

FIGS. 3a and 3b show a vehicle 20 comprising in a plurality of hollow profiles 1 that are attached to the floor 22 of the vehicle, for example by means of attachment means such as screws or bolts. To each hollow profile 1 a respective mounting profile 23 is attached by screwing screws or bolts 24 in said threaded bushings 11, which mounting profiles 23 are arranged for mounting in this embodiment chairs 21 to the floor of the vehicle 20.

It is noted that the invention is not limited to the shown embodiments but also extends to variants within the scope of the appended claims.

1. A method for making at least one threaded bushing in a hollow profile, the method comprising:
a) providing a hollow profile;
b) friction drilling the hollow profile using a friction drilling tool, wherein said friction drilling tool is pressed against a first wall that extends substantially orthogonal to a longitudinal direction of the drilling tool and thereby melts through and deforms said first wall and after passing through the first wall contacts and thereby melts and deforms at least two second walls of the hollow profile that extend substantially orthogonal with respect to said first wall and thereby substantially parallel to said longitudinal direction of the friction drilling tool, such that a substantially cylindrical shaped bushing is formed in the hollow profile; and
c) screw thread tapping said substantially cylindrical shaped bushing using a thread tapping tool, thereby obtaining said at least one threaded bushing.

2. The method according to claim 1, wherein in step b) the friction drilling tool is pressed against at least one third wall that extends substantially orthogonal between the second walls and parallel to the first wall at a distance therefrom and thereby melts through and deforms said third wall, said deformed third wall defining part of the substantially cylindrical shaped bushing.

3. The method according to claim 2, wherein the second walls extend on both sides of the at least one third wall as seen in the longitudinal direction of the friction drilling tool.

4. The method according to claim 1 any of the preceding claims, wherein a part of the hollow profile comprising said first, second, and third walls is substantially A-shaped prior to step b).

5. The method according to claim 1, wherein a length of the threaded bushing is substantially equal to a length of the second walls.

6. A hollow profile comprising the at least one threaded bushing as obtained by performing the method of claim 1.

7. The hollow profile according to claim 6, wherein said hollow profile is a vehicle floor profile.

8. The hollow profile according to claim 6, wherein the hollow profile is an elongated profile having a length in a length direction that is larger than a width in a width direction.

9. The hollow profile according to claim 8, wherein said length direction and width direction are orthogonal to each other and both lie in a plane of a first wall of the profile.

10. The hollow profile according to claim 6, wherein the hollow profile comprises multiple threaded bushings as obtained by:
friction drilling the hollow profile using a friction drilling tool, wherein said friction drilling tool is pressed against a first wall that extends substantially orthogonal to a longitudinal direction of the drilling tool and thereby melts through and deforms said first wall and after passing through the first wall contacts and thereby melts and deforms at least two second walls of the hollow profile that extend substantially orthogonal with respect to said first wall and thereby substantially parallel to said longitudinal direction of the friction drilling tool, such that a substantially cylindrical shaped bushing is formed in the hollow profile; and
screw thread tapping said substantially cylindrical shaped bushing using a thread tapping tool, thereby obtaining said at least one threaded bushing.

11. The hollow profile according to claim 6, wherein the hollow profile comprises a first wall and at least two second walls that extend substantially orthogonal with respect to said first wall, wherein the second walls extend over substantially the entire length of the profile, and wherein the at least one threaded bushing is provided at any desired location.

12. The hollow profile according to claim 11, wherein the threaded bushing is obtained by locally deforming the first and second walls by means of said friction drilling tool and wherein outside the at least one threaded bushing the first and second walls remain undeformed and extend from the at least one threaded bushing in the length direction of said hollow profile.

13. The hollow profile according to claim 11, wherein the first wall and the at least two second walls are integrally formed as one piece over substantially the entire length of the hollow profile.

14. A vehicle, comprising at least one hollow profile according to claim 6, wherein the hollow profile is attached to a floor of the vehicle.

15. The vehicle according to claim 14, wherein a mounting profile is attached to the hollow profile by means of at least one screw or bolt that is screwed into a respective at least one threaded bushing.

16. The vehicle according to claim 15, wherein the mounting profile is arranged for mounting furniture.

17. The vehicle according to claim 15, wherein the mounting profile is arranged for mounting a wheelchair restraint.
